(19) United States
(12) Patent Application Publication
(10) Pub. No.: US 2025/0305817 A1
(43) Pub. Date: Oct. 2, 2025

(54) MEASUREMENT APPARATUS

(71) Applicant: FUJIFILM Business Innovation Corp., Tokyo (JP)

(72) Inventors: Kouhei YUKAWA, Kanagawa (JP); Yoshinori SHIRAKAWA, Kanagawa (JP); Kenichi ITO, Kanagawa (JP)

(73) Assignee: FUJIFILM Business Innovation Corp., Tokyo (JP)

(21) Appl. No.: 18/769,810

(22) Filed: Jul. 11, 2024

(30) Foreign Application Priority Data
Mar. 26, 2024 (JP) 2024-050431

(51) Int. Cl. G01B 11/30

(52) U.S. Cl. CPC G01B 11/303

(57) ABSTRACT

A measurement apparatus includes: an irradiator configured to radiate light to a surface of a measurement target; a light receiver that includes a light receiving element to receive light reflected by the surface, and is configured to amplify and output an output value corresponding to an amount of the light received; a changer configured to change the output value of the light receiver by changing at least one of an amplification factor of the output value of the light receiver or an amount of light irradiation of the irradiator; and a measurer configured to measure a surface property of the measurement target using output value data in which the output value is close to a predetermined reference value in a changeable range of the output value.

### CROSS-REFERENCE TO RELATED APPLICATIONS

This application is based on and claims priority under 35 USC 119 from Japanese Patent Application No. 2024-050431 filed Mar. 26, 2024.

### BACKGROUND

### (i) Technical Field

The present disclosure relates to a measurement apparatus.

### (ii) Related Art

Japanese Unexamined Patent Application Publication No. 2023-148545 discloses a paper type identification device including: a measuring unit configured to measure a feature value of one side of a sheet which is an identification target; and a control unit configured to identify a type of the sheet based on a result of measurement by the measuring unit, wherein the control unit is configured to, when measurement of the feature value of the one side of the sheet by the measuring unit is finished, send notification to prompt a user to measure the other side of the sheet.

### SUMMARY

As a measurement apparatus, the one may be adopted, including: an irradiator configured to radiate light to a surface of a measurement target; a light receiver that includes a light receiving element to receive light reflected by the surface, and configured to amplify and output an output value corresponding to an amount of the light received; and a measurer configured to measure a surface property of the measurement target using output value data of the output value output by the light receiver.

The surface property of a measurement target significantly varies with the type of the measurement target, and the amount of light received by the light receiving element significantly varies with the type of the measurement target. For example, when the smoothness of the surface of a measurement target is high, the amount of light received by the light receiving element is large, and when the smoothness of the surface of a measurement target is low, the amount of light received by the light receiving element is small.

In a configuration in which the amplification factor of the output value of the light receiver and the amount of light irradiation of the irradiator are constant, if the amplification factor and the amount of light irradiation are set low to cope with a measurement target with high smoothness, the resolution reduces, and if the amplification factor and the amount of light irradiation are set high to cope with a measurement target with low smoothness, when a measurement target with high smoothness is measured, the output is saturated. Therefore, in a configuration in which the amplification factor and the amount of light irradiation are constant, depending on the setting of the amplification factor and the amount of light irradiation, the measurement accuracy may be reduced when the surface property of a measurement target is measured.

Aspects of non-limiting embodiments of the present disclosure relate to implementation of further improved measurement accuracy when the surface property of a measurement target is measured, as compared to when the amplification factor of the output value of the light receiver and the amount of light irradiation of the irradiator are constant.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a measurement apparatus including: an irradiator configured to radiate light to a surface of a measurement target; a light receiver that includes a light receiving element to receive light reflected by the surface, and is configured to amplify and output an output value corresponding to an amount of the light received; a changer configured to change the output value of the light receiver by changing at least one of an amplification factor of the output value of the light receiver or an amount of light irradiation of the irradiator; and a measurer configured to measure a surface property of the measurement target using output value data in which the output value is close to a predetermined reference value in a changeable range of the output value.

### BRIEF DESCRIPTION OF THE DRAWINGS

Exemplary embodiments of the present disclosure will be described in detail based on the following figures, wherein:

FIG. 1 is a schematic diagram illustrating a measurement apparatus according to an exemplary embodiment;

FIG. 2 is a block diagram illustrating an example of a hardware configuration of the measurement apparatus according to the exemplary embodiment;

FIG. 3 is a block diagram illustrating an example of a functional configuration of a control device in the measurement apparatus according to the exemplary embodiment;

FIG. 4 is a flowchart illustrating an example of a flow of a measurement process performed by the measurement apparatus according to the exemplary embodiment.

### DETAILED DESCRIPTION

Hereinafter, an example of an exemplary embodiment according to the present disclosure will be described with reference to the drawings.

### <Measurement Apparatus 10>

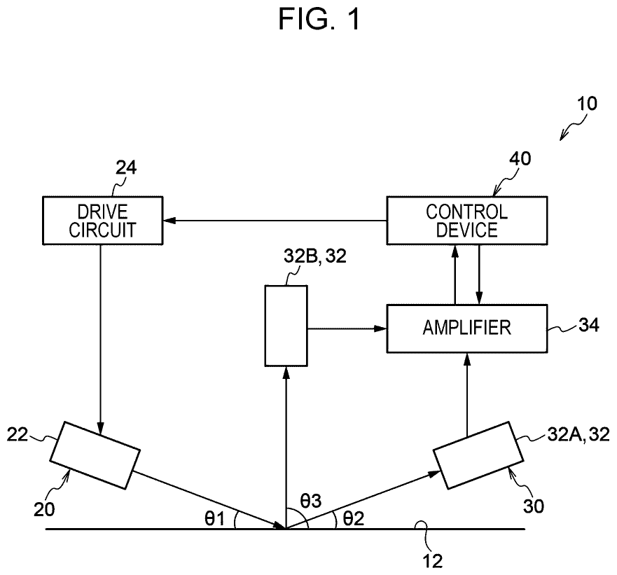

The configuration of a measurement apparatus 10 according to the exemplary embodiment will be described. FIG. 1 is a schematic diagram illustrating the configuration of the measurement apparatus 10 according to the exemplary embodiment.

The measurement apparatus 10 is an apparatus that measures the surface property of a measurement target 12. Specifically, the measurement apparatus 10 measures the surface smoothness (in other words, the microscopic irregularities) of the measurement target 12. In the exemplary embodiment, as illustrated in FIG. 1, the measurement apparatus 10 includes an irradiator 20, a light receiver 30, and a control device 40.

The irradiator 20 is a component that radiates light to the surface of the measurement target 12. Specifically, the irradiator 20 includes a light emitting element 22, and a drive circuit 24. The light emitting element 22 is an element that emits light to the surface of the measurement target 12. As the light emitting element 22, an element such as a light emitting diode (LED) can be used. The drive circuit 24 is a circuit that drives the light emitting element 22. The drive circuit 24 drives the light emitting element 22, thus the irradiator 20 radiates light to the measurement target 12, and the light is reflected by the measurement target 12.

In the irradiator 20, the light emitting element 22 diagonally radiates light to the measurement target 12. An irradiation angle θ1 of the light emitting element 22 with respect to the measurement target 12 is set to a value less than e.g., 90 degrees, preferably, set to 45 degrees or less, more preferably, set to 30 degrees or less.

The light receiver 30 is a component that receives the light reflected by the surface of the measurement target 12. Specifically, the light receiver 30 includes a plurality of light receiving elements 32, and an amplifier 34. Each of the plurality of light receiving elements 32 is an element that receives the light reflected by the surface of the measurement apparatus 10. As the light receiving element 32, an elements such as a photodiode can be used. In the exemplary embodiment, the plurality of light receiving elements 32 consist of two light receiving elements 32A, 32B.

The amplifier 34 is comprised of e.g., an electric circuit including an amplifier circuit, and amplifies a received light signal which has been generated by each of the light receiving elements 32A, 32B receiving reflected light. Thus, the light receiver 30 amplifies and outputs an output value corresponding to the amount of light received by the light receiving elements 32A, 32B. Note that the output value is output as a voltage value (V), for example.

In the light receiver 30, the light receiving element 32A receives reflection light reflected diagonally with respect to the measurement target 12. A received light angle θ2 of the light receiving element 32A with respect to the measurement target 12 is set to a value less than e.g., 90 degrees, preferably, set to 45 degrees or less, more preferably, set to 30 degrees or less. In the exemplary embodiment, the received light angle θ2 is set to be equal to the irradiation angle θ1, and the light receiving element 32A receives reflection light specularly reflected by the measurement target 12.

In the light receiving element 32B, received light angle θ3 with respect to the measurement target 12 is set to an angle greater than the received light angle θ2. In the exemplary embodiment, the received light angle θ3 is set to e.g., 90 degrees, and the light receiving element 32B receives reflection light reflected perpendicularly to the measurement target 12. Therefore, the light receiving element 32B receives part of reflection light diffusely reflected by the measurement target 12.

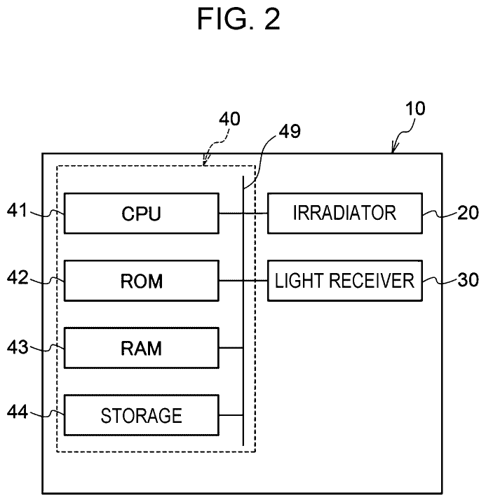

The control device 40 is a device that controls the components (the irradiator 20 and the light receiver 30) of the measurement apparatus 10. The control device 40 has the function as a computer, and as illustrated in FIG. 2, includes a central processing unit (CPU) 41, a read only memory (ROM) 42, a random access memory (RAM) 43, and a storage 44. The CPU 41, ROM 42, RAM 43 and storage 44 are coupled to each other via a bus 49.

The CPU 41 is a central processing unit, and executes various programs including an information processing program, and controls the components. The ROM 42 stores various programs including an information processing program, and various data. The RAM 43 temporarily stores programs or data as a work area.

The storage 44 is comprised of one or multiple storage media, such as a hard disk drive (HDD), a solid state drive (SSD) or a flash memory, and stores various programs including an operating system, and various data. Note that the information processing program may be stored in the storage 44.

In the control device 40, the CPU 41 reads various programs including the information processing program from the ROM 42 or the storage 44, and executes the programs using the RAM 43 as a work area. The CPU 41 executes the information processing program, thereby implementing various functions.

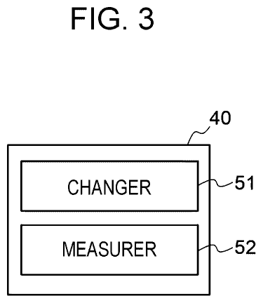

In the control device 40, as illustrated in FIG. 3, the CPU 41 functions as a changer 51, and a measurer 52 by executing the information processing program.

The changer 51 is configured to change the output value of the light receiver 30 by changing the amount of light irradiation of the irradiator 20. The measurer 52 measures the surface property of the measurement target 12 using output value data in which the output value is close to a predetermined reference value in a changeable range of the output value of the light receiver 30.

In the exemplary embodiment, the changer 51 is configured to change the output value for each of the light receiving elements 32A, 32B of the light receiver 30 by increasing the amount of light irradiation of the irradiator 20 stepwisely. In the exemplary embodiment, as an example, the changer 51 increases the amount of light irradiation stepwisely in 7 levels: light amount 1 to 7.

The measurer 52 measures the surface property of the measurement target 12 using output value data in which the output value of the light receiver 30 exceeds a reference value for the first time. Specifically, the changer 51 and the measurer 52 perform the later-described measurement process.

### <Measurement Process According to Exemplary Embodiment>

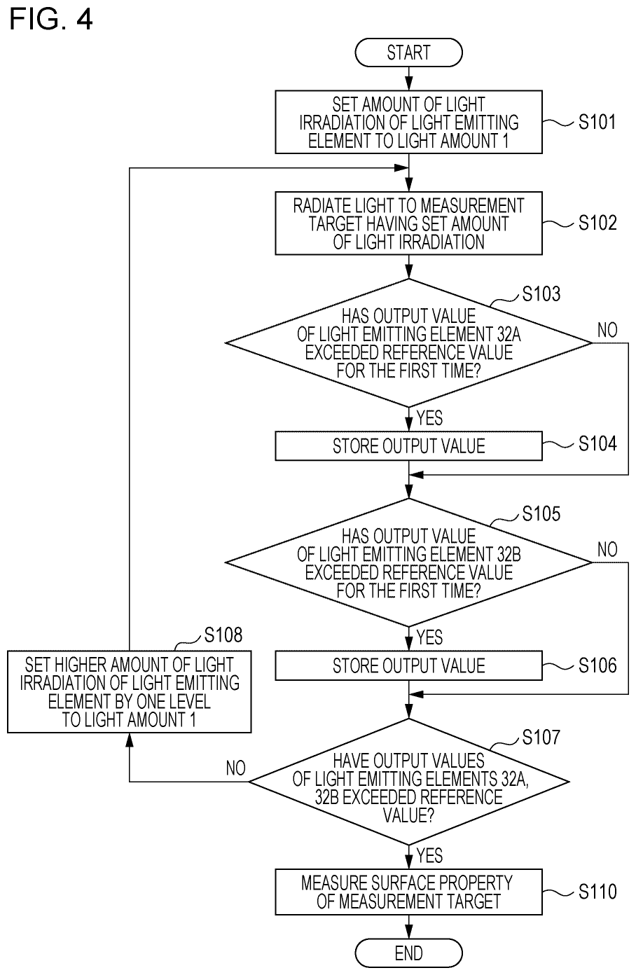

Next, an example of a measurement process according to the exemplary embodiment will be described. FIG. 4 is a flowchart illustrating an example of a flow of a measurement process performed by the measurement apparatus 10.

The present process is performed by the CPU 41 reading the information processing program from the ROM 42 or the storage 44, and executing the program. As an example, the present process is started when the CPU 41 obtains an execution order to cause the measurement apparatus 10 to perform the measurement process.

As illustrated in FIG. 4, when starting the present process, the CPU 41 sets the amount of light irradiation of the light emitting element 22 to light amount 1 (in other words, a minimum value) (step S101), and causes the irradiator 20 to perform an irradiation process of radiating light to the measurement target 12 with the set amount of light irradiation (step S102).

Next, the CPU 41 determines whether the output value of the light receiver 30, corresponding to the amount of light received by the light receiving element 32A has exceeded a reference value for the first time (step S103).

When the CPU 41 determines that the output value has exceeded a reference value for the first time (YES in step S103), the output value is stored as a result of measurement in the light receiving element 32A (step S104), and the flow proceeds to step S105. The result of measurement is stored in e.g., the storage 44.

When the CPU 41 does not determine that the output value has exceeded a reference value for the first time (NO in step S103), the flow proceeds to step S105 without performing step S104. Note that “when the CPU 41 does not determine that the output value has exceeded a reference value for the first time” includes “when the output value has not reached a reference value” and “when the output value has already exceeded a reference value, in other words, when the output value has exceeded a reference value for the second or later time”.

In step S105, the CPU 41 determines whether the output value of the light receiver 30, corresponding to the amount of light received by the light receiving element 32B has exceeded a reference value for the first time.

When the CPU 41 determines that the output value has exceeded a reference value for the first time (YES in step S105), the output value is stored as a result of measurement in the light receiving element 32B (step S106), and the flow proceeds to step S107. The result of measurement is stored in e.g., the storage 44.

When the CPU 41 does not determine that the output value has exceeded a reference value for the first time (NO in step S105), the flow proceeds to step S107 without performing step S106. Note that “when the CPU 41 does not determine that the output value has exceeded a reference value for the first time” includes “when the output value has not reached a reference value” and “when the output value has already exceeded a reference value, in other words, when the output value has exceeded a reference value for the second or later time”.

In step S107, the CPU 41 determines whether both output values of the light receiver 30, corresponding to the amounts of light received by the light receiving elements 32A, 32B have exceeded a reference value.

When the CPU 41 determines that the output value has exceeded a reference value, the flow proceeds to step S110, and when the CPU 41 does not determine that the output value has exceeded a reference value, the flow proceeds to step S108.

In step S110, the CPU 41 measures the surface property (specifically, the smoothness) of the measurement target 12 based on the data of the output value stored in step S104 and step S106, then the present process is completed.

When the smoothness of the surface of the measurement target 12 is high (in other words, when the microscopic irregularities are small), the component of the amount of light specularly reflected is relatively large, thus the output value corresponding to the amount of light received by the light receiving element 32A becomes relatively high, and the output value corresponding to the amount of light received by the light receiving element 32B becomes relatively low. On the other hand, when the smoothness of the surface of the measurement target 12 is low (in other words, when the microscopic irregularities are large), the component of the amount of light specularly reflected is relatively small, thus the output value corresponding to the amount of light received by the light receiving element 32A becomes relatively low, and the output value corresponding to the amount of light received by the light receiving element 32B becomes relatively high. By utilizing these, it is possible to measure the surface property (specifically, the smoothness) of the measurement target 12.

In step S108, the CPU 41 increases the amount of light irradiation of the light emitting element 22 by one level, and the flow proceeds to step S102. Thus, in the present process, steps S102 to 106 are repeated until both output values of the light receiver 30, corresponding to the amounts of light received by the light receiving elements 32A, 32B exceed a reference value.

### Operation of Exemplary Embodiment

In the exemplary embodiment, the CPU 41 changes the output value of the light receiver 30 by changing the amount of light irradiation of the irradiator 20. The CPU 41 measures the surface property of the measurement target 12 using output value data in which the output value is close to a predetermined reference value in a changeable range of the output value of the light receiver 30.

In a configuration (hereinafter referred to as a configuration A) in which the amount of light irradiation of the irradiator 20 is constant, if the amount of light irradiation is set low to cope with the measurement target 12 with high smoothness, the resolution reduces, and if the amount of light irradiation is set high to cope with the measurement target 12 with low smoothness, when a measurement target with high smoothness is measured, the output is saturated. Therefore, in the configuration A, depending on the setting of the amount of light irradiation, the measurement accuracy may be reduced when the surface property of the measurement target 12 is measured.

In contrast, the CPU 41 changes the output value of the light receiver 30 by changing the amount of light irradiation of the irradiator 20, and measures the surface property of the measurement target 12 using output value data in which the output value is close to a predetermined reference value in a changeable range of the output value of the light receiver 30, thus as compared to the configuration A, the accuracy of the measurement of the surface property of the measurement target 12 can be improved.

In the exemplary embodiment, the CPU 41 changes the output value of the light receiver 30 by increasing the amount of light irradiation of the irradiator 20 stepwisely, and measures the surface property of the measurement target 12 using output value data in which the output value of the light receiver 30 exceeds a reference value for the first time.

Thus, in a configuration in which the output value of the light receiver 30 is changed by increasing the amount of light irradiation of the irradiator 20 stepwisely, as compared to when output value data is used in which the output value of the light receiver 30 falls below a reference value, output value data close to a reference value can be used.

In the exemplary embodiment, the CPU 41 changes the output value for each of the light receiving elements 32A, 32B, and for the output value of each of the light receiving elements 32A, 32B, measures the surface property of the measurement target 12 using output value data which exceeds a reference value for the first time.

Thus, as compared to when the surface property of the measurement target 12 is measured using output value data in which the output value of either one of the light receiving elements 32A, 32B exceeds a reference value for the first time, output value data close to a reference value can be used for each of the light receiving elements 32A, 32B.

### <Modification of Measurement Process>

In the exemplary embodiment, the CPU 41 changes the output value of the light receiver 30 by changing the amount of light irradiation of the irradiator 20, but the present disclosure is not limited to this.

The CPU 41 may be configured to change the output value of the light receiver 30, for example, by changing the amplification factor of the output value in the light receiver 30. In addition, the CPU 41 may be configured to change the output value of the light receiver 30, for example, by changing both the amount of light irradiation of the irradiator 20 and the amplification factor of the output value in the light receiver 30. Thus, the CPU 41 may be configured to change the output value of the light receiver 30 by changing at least one of the amount of light irradiation of the irradiator 20 or the amplification factor of the output value in the light receiver 30.

In the exemplary embodiment, the CPU 41 changes the output value of the light receiver 30 by increasing the amount of light irradiation of the irradiator 20 stepwisely, and measures the surface property of the measurement target 12 using output value data in which the output value of the light receiver 30 exceeds a reference value for the first time, but the present disclosure is not limited to this.

The CPU 41 may change the output value of the light receiver 30 by increasing the amount of light irradiation of the irradiator 20 continuously. Alternatively, the CPU 41 may change the output value of the light receiver 30 by increasing the amplification factor of the output value in the light receiver 30 continuously or stepwisely.

In the exemplary embodiment, the CPU 41 may change the output value of the light receiver 30 by decreasing at least one of the amount of light irradiation of the irradiator 20 or the amplification factor of the output value in the light receiver 30 continuously or stepwisely, and may measure the surface property of the measurement target 12 using output value data in which the output value of the light receiver 30 falls below a reference value for the first time.

According to this modification, in a configuration in which the CPU 41 changes the output value of the light receiver 30 by decreasing at least one of the amount of light irradiation of the irradiator 20 or the amplification factor of the output value in the light receiver 30 continuously or stepwisely, as compared to when output value data is used in which the output value of the light receiver 30 exceeds a reference value, the CPU 41 can use output value data close to a reference value.

In addition, in the modification, the CPU 41 may change the output value for each of the light receiving elements 32A, 32B, and for the output value of each of the light receiving elements 32A, 32B, may measure the surface property of the measurement target 12 using output value data in which the output value of the light receiver 30 falls below a reference value for the first time.

According to this modification, as compared to when the surface property of the measurement target 12 is measured using output value data in which the output value of either one of the light receiving elements 32A, 32B falls below a reference value for the first time, output value data close to a reference value can be used for each of the light receiving elements 32A, 32B.

### <Modification of Irradiator 20>

In the irradiator 20 of the exemplary embodiment, a light emitting diode (LED) is used as the light emitting element 22, but the present disclosure is not limited to this. As the irradiator 20, a light emitting element 22 such as a laser diode may be used, and various irradiators can be used. The irradiator 20 may be a component capable of radiating light to the surface of the measurement target 12.

### <Modification of Light Receiver 30>

In the light receiver 30 of the exemplary embodiment, a photodiode is used as the light receiving element 32, but the present disclosure is not limited to this. As the light receiver 30, a light receiving element 32 such as a phototransistor may be used, and various light receivers can be used. The light receiver 30 may be a component that receives reflection light reflected by the surface of the measurement target 12.

In the exemplary embodiment, the light receiver 30 includes the light receiving elements 32A, 32B as the light receiving element 32, but the present disclosure is not limited to this. The light receiving element 32 may be a single light receiving element, or may be comprised of three or more light receiving elements. All of a plurality of light receiving elements 32 may receive reflection light diffusely reflected by the measurement target 12.

### <Supplement for Measurement Apparatus 10 and Modifications>

The measurement apparatus 10 may be used, for example, as an apparatus that determines the presence or absence of a coating layer of a recording medium, the type of a recording medium used in an image forming apparatus that forms an image. In this case, the measurement apparatus 10 measures the smoothness of the surface of a recording medium as the measurement target 12, and determines the presence or absence of a coating layer of the recording medium, and the type of the recording medium based on a result of the measurement.

In this case, the measurement apparatus 10 may be included in the image forming apparatus as a component thereof. In addition, the measurement apparatus 10 may measure other properties of the recording medium. The properties include the basis weight, and the electric resistance of the recording medium. The basis weight can be measured based on the amount of attenuation of ultrasonic waves when applied to the recording medium. The electric resistance can be measured based on the current value when a voltage is applied to the recording medium.

In addition, based on the presence or absence of a coating layer of the recording medium, the type of the recording medium, and the other properties which are determined by the measurement apparatus 10, it is possible to set the process conditions for the image forming processes in the image forming apparatus. When the image forming apparatus is an electrophotographic system image forming apparatus that performs the processes of charging, exposure, developing, and transfer, the process conditions include a transfer voltage and a fixing temperature.

Note that an example of a measurement target of the measurement apparatus 10 is not limited to a recording medium, and may be used for application other than forming an image, or may be a target for which the surface property is measured.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

The present disclosure is not limited to the above-described exemplary embodiment, and various modifications, changes, and improvements are possible in a range not departing from the spirit of the present disclosure. For example, plural of the modifications described above may be combined as appropriate.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

### APPENDIX

(((1)))

A measurement apparatus comprising:
an irradiator configured to radiate light to a surface of a measurement target;
a light receiver that includes a light receiving element to receive light reflected by the surface, and is configured to amplify and output an output value corresponding to an amount of the light received;
a changer configured to change the output value of the light receiver by changing at least one of an amplification factor of the output value of the light receiver or an amount of light irradiation of the irradiator; and
a measurer configured to measure a surface property of the measurement target using output value data in which the output value is close to a predetermined reference value in a changeable range of the output value.
   (((2)))

The measurement apparatus according to (((1))),
wherein the changer is configured to:
change the output value of the light receiver by increasing at least one of the amplification factor of the output value of the light receiver or the amount of light irradiation of the irradiator continuously or stepwisely, and
the measurer is configured to:
measure the surface property of the measurement target using output value data in which the output value of the light receiver exceeds the reference value for a first time.
   (((3)))

The measurement apparatus according to (((2))),
wherein the light receiver includes a plurality of light receiving elements each of which is the light receiving element,
the changer is configured to change the output value for the light receiving element, and
the measurer is configured to:
for the output value of each of the plurality of light receiving elements, measure the surface property of the measurement target using output value data in which the output value of the light receiver exceeds the reference value for a first time.
   (((4)))

The measurement apparatus according to any one of (((1))) to (((3))),
wherein the changer is configured to:
change the output value of the light receiver by decreasing at least one of the amplification factor of the output value of the light receiver or the amount of light irradiation of the irradiator continuously or stepwisely, and
the measurer is configured to:
measure the surface property of the measurement target using output value data in which the output value of the light receiver falls below the reference value for a first time.
   (((5)))

The measurement apparatus according to (((4))),
wherein the light receiver includes a plurality of light receiving elements each of which is the light receiving element,
the changer is configured to change the output value for the light receiving element, and
the measurer is configured to:
for the output value of each of the plurality of light receiving elements, measure the surface property of the measurement target using output value data in which the output value of the light receiver falls below the reference value for a first time.

What is claimed is:

1. A measurement apparatus comprising:
an irradiator configured to radiate light to a surface of a measurement target;
a light receiver that includes a light receiving element to receive light reflected by the surface, and is configured to amplify and output an output value corresponding to an amount of the light received;
a changer configured to change the output value of the light receiver by changing at least one of an amplification factor of the output value of the light receiver or an amount of light irradiation of the irradiator; and
a measurer configured to measure a surface property of the measurement target using output value data in which the output value is close to a predetermined reference value in a changeable range of the output value.

2. The measurement apparatus according to claim 1,
wherein the changer is configured to:
change the output value of the light receiver by increasing at least one of the amplification factor of the output value of the light receiver or the amount of light irradiation of the irradiator continuously or stepwisely, and
the measurer is configured to:
measure the surface property of the measurement target using output value data in which the output value of the light receiver exceeds the reference value for a first time.

3. The measurement apparatus according to claim 2,
wherein the light receiver includes a plurality of light receiving elements each of which is the light receiving element,
the changer is configured to change the output value for the light receiving element, and
the measurer is configured to:
for the output value of each of the plurality of light receiving elements, measure the surface property of the measurement target using output value data in which the output value of the light receiver exceeds the reference value for a first time.

4. The measurement apparatus according to claim 1,
wherein the changer is configured to:
change the output value of the light receiver by decreasing at least one of the amplification factor of the output value of the light receiver or the amount of light irradiation of the irradiator continuously or stepwisely, and
the measurer is configured to:
measure the surface property of the measurement target using output value data in which the output value of the light receiver falls below the reference value for a first time.

5. The measurement apparatus according to claim 4,
wherein the light receiver includes a plurality of light receiving elements each of which is the light receiving element,
the changer is configured to change the output value for the light receiving element, and
the measurer is configured to:
for the output value of each of the plurality of light receiving elements, measure the surface property of the measurement target using output value data in which the output value of the light receiver falls below the reference value for a first time.

6. A measurement apparatus comprising:
means for radiating light to a surface of a measurement target;
means for receiving light reflected on the surface by a light receiving element included in the means for receiving light, and for amplifying and outputting an output value corresponding to an amount of the light received;
means for changing the output value of the means for receiving light by changing at least one of an amplification factor of the output value of the means for receiving light or an amount of light irradiation of the means for radiating light; and
means for measuring a surface property of the measurement target using output value data in which the output value is close to a predetermined reference value in a changeable range of the output value.
